(19) United States
(12) Patent Application Publication
(10) Pub. No.: US 2011/0117420 A1
(43) Pub. Date: May 19, 2011

(54) BUS BAR AND BATTERY MODULE INCLUDING THE SAME

(76) Inventors: Sung-Bae Kim, Yongin-si (KR); Yong-Sam Kim, Yongin-si (KR); Sang-Won Byun, Yongin-si (KR)

(21) Appl. No.: 12/797,423

(22) Filed: Jun. 9, 2010

(30) Foreign Application Priority Data
Nov. 19, 2009 (KR) 10-2009-0112199

(51) Int. Cl. H01M 2/24; H01M 4/02

(52) U.S. Cl. 429/158; 429/211

(57) ABSTRACT

A battery module includes a plurality of secondary batteries, each of the secondary batteries having a first terminal and a second terminal comprising different metals; and a plurality of bus bars, each of the bus bars including a first connecting portion comprising a first metal and connected to the first terminal of one of the secondary batteries, and a first end portion, and a second connecting portion comprising a second metal different from the first metal and connected to the second terminal of another one of the secondary batteries adjacent to the one secondary battery, and a second end portion, wherein the first end portion is connected to the second end portion by a weld.

### CROSS-REFERENCE TO RELATED APPLICATION

This application claims the benefit of Korean Patent Application No. 10-2009-0112199, filed on Nov. 19, 2009, in the Korean Intellectual Property Office, the disclosure of which is incorporated herein in its entirety by reference.

### BACKGROUND

1. Field

One or more embodiments of the present invention relate to a bus bar and a battery module including the same.

2. Description of the Related Art

Small devices which are driven by a small amount of electric power may use only one secondary battery; however, devices requiring a large amount of electric power use a battery module including a plurality of secondary batteries. For example, electric cars, hybrid cars, and uninterruptible power supplies (UPS) include a battery module, in which a plurality of secondary batteries are connected in series to supply a large amount of electric power.

In general, when configuring a battery module by connecting a plurality of secondary batteries in series, positive terminals and negative terminals of adjacent secondary batteries are connected to each other by using bus bars. The bus bars are fabricated as a metal plate having electrical conductivity, and maintain a connection between the secondary batteries firmly so as to transfer electricity well.

Lithium secondary batteries are widely used as the secondary batteries (hereinafter, referred to as unit batteries) of the battery module. Metal such as aluminum (Al) is used to form the positive terminal of the lithium secondary battery, and metal such as copper (Cu) or nickel (Ni) is used to form the negative terminal of the lithium secondary battery so that electric chemical reactions may occur therebetween.

Many battery modules have a structure in which a unit battery and a bus bar are connected to each other via welding. The bus bar is formed of a metal material such as Cu or Al in order to ensure sufficient electrical conductivity. However, if the bus bar is formed of Al, for example, it is difficult to weld the bus bar to a Cu negative terminal. In addition, when materials are different from each other, a contact electrical resistance increases.

A terminal of the unit battery and the bus bar may be connected to each other by forming a screw surface on an outer surface of terminal of the unit battery and using a nut coupled to the screw surface, instead of using the welding method. However, even when the unit battery and the bus bar are connected to each other via the nut, corrosion may occur between the bus bar and the terminal of the unit battery, when formed of different materials from each other.

### SUMMARY

One or more embodiments of the present invention include a battery module, in which corrosion between a bus bar and a terminal of a unit battery may be reduced and a contact electrical resistance may be reduced.

One or more embodiments of the present invention include a bus bar suitable for connecting secondary batteries having terminals formed of different metal materials, and a battery module including the bus bar.

Additional aspects will be set forth in part in the description which follows and, in part, will be apparent from the description.

According to one or more embodiments of the present invention, a bus bar for a battery module is provided including a first connecting portion made of a first conductive metal material, the first connecting portion having a first opening configured to be connected to a first terminal of a secondary battery, and an end portion; and a second connecting portion made of a second conductive metal material different from the first conductive metal material, the second connecting portion having a second opening configured to be connected to a second terminal of the secondary battery, and an end portion connected to the end portion of the first connecting portion by a weld.

In one embodiment, the weld is a tungsten inert gas weld. Further, the first conductive metal material may be aluminum and the second conductive metal material may be copper or nickel, for example.

According to another embodiment of the present invention, a battery module is provided including a plurality of secondary batteries, each of the secondary batteries having a first terminal and a second terminal made of different metals; and a plurality of bus bars, each of the bus bars including a first connecting portion made of a first metal and connected to the first terminal of one of the secondary batteries, and a first end portion, and a second connecting portion made of a second metal different from the first metal and connected to the second terminal of another one of the secondary batteries adjacent to the one secondary battery, and a second end portion, wherein the first end portion is connected to the second end portion by a weld.

In one embodiment, the first metal is substantially the same as the metal of the first terminal, and wherein the second metal is substantially the same as the metal of the second terminal. Further, in one embodiment, the first connecting portion has a first opening generally corresponding to the first terminal, the second connecting portion has a second opening generally corresponding to the second terminal, the first terminal and the second terminal each have a threaded outer surface and protrude from the first opening and the second opening, respectively, and nuts are coupled to the threaded outer surface of the first and second terminals to connect the first terminal and the second terminal to the first connecting portion and the second connecting portion, respectively. The first connecting portion and the first terminal and the second connecting portion and the second terminal may be connected to each other, respectively, by a weld.

### BRIEF DESCRIPTION OF THE DRAWINGS

These and/or other aspects will become apparent and more readily appreciated from the following description of the embodiments, taken in conjunction with the accompanying drawings of which:

FIG. 1 is a perspective view of a battery module according to an embodiment of the present invention;

FIG. 2 is a cross-sectional view of a portion of the battery module of FIG. 1;

FIG. 3 is a cross-sectional view of a bus bar of the battery module of FIG. 1; and

FIG. 4 is a plan view of the bus bar of FIG. 3.

### DETAILED DESCRIPTION

Reference will now be made in detail to embodiments, examples of which are illustrated in the accompanying drawings, wherein like reference numerals refer to the like elements throughout. In this regard, the present embodiments may have different forms and should not be construed as being limited to the descriptions set forth herein. Accordingly, the embodiments are merely described below, by referring to the figures, to explain aspects of the present description.

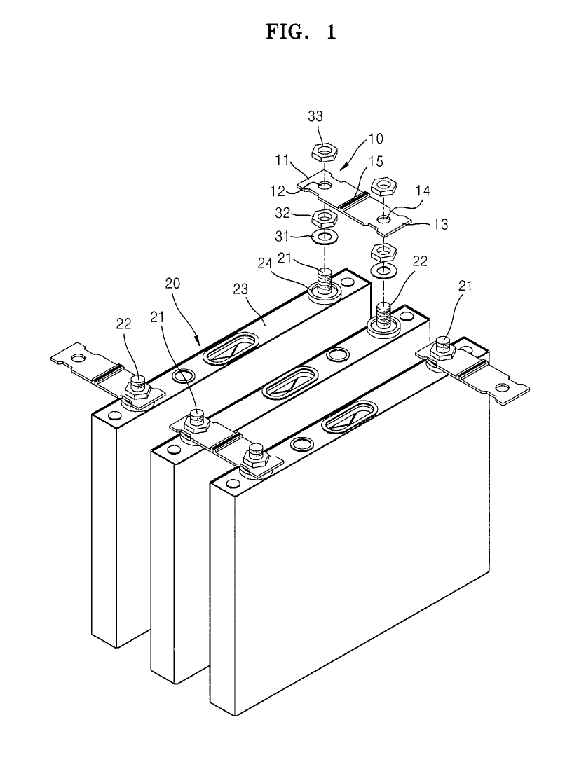

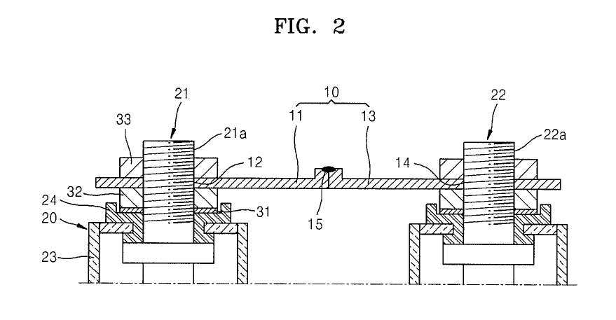

FIG. 1 is a perspective view of a battery module according to an embodiment of the present invention, and FIG. 2 is a cross-sectional view of the battery module of FIG. 1.

The battery module according to the present embodiment shown in FIGS. 1 and 2 includes a plurality of secondary batteries 20 and a plurality of bus bars 10 connecting terminals 21 and 22 of adjacent secondary batteries 20.

The battery module has a structure in which the plurality of secondary batteries 20 are connected to each other in series by the bus bars 10. A case 23 is included as part of each of the secondary batteries 20, and an electrode assembly is housed in the case 23. The electrode assembly has a positive electrode and a negative electrode and a separator located therebetween.

However, the battery module according to the present invention is not limited to the structure described above, in which the secondary batteries 20 are connected in series, and instead, the secondary batteries 20 may be realized in other formats. For example, a plurality of cylindrical batteries, instead of the electrode assembly, may be housed in the case 23 of the secondary batteries 20. Here, the cylindrical batteries may be connected to each other in series or in parallel in the case 23.

The first terminal 21 and the second terminal 22 of each of the secondary batteries 20 are formed of a conductive metal and have different polarities from each other. For example, when the secondary batteries 20 are lithium secondary batteries and the first terminal 21 is a negative terminal, the first terminal 21 may include copper (Cu) or nickel (Ni). Here, the second terminal 22 is a positive terminal, and may include aluminum (Al).

The secondary batteries 20 are located at predetermined intervals so that the first terminal 21 and the second terminal 22 may be alternately oriented. In the plurality of secondary batteries 20, the first and second terminals 21 and 22 of adjacent secondary batteries 20 are connected to each other to complete assembling of the battery module.

Each of the bus bars 10, which connect the secondary batteries 20 to each other, includes a first connecting portion 11 and a second connecting portion 13 formed of different metal materials from each other. The first connecting portion 11 is connected to the first terminal 21 of the secondary batteries 20, and the second connecting portion 13 is connected to the second terminal 22 of the secondary batteries 20.

The first connecting portion 11 and the second connecting portion 13 are formed of different metal materials from each other. The first connecting portion 11 may be formed of Cu or Ni, which also forms the first terminal 21, and the second connecting portion 13 may be formed of Al, which also forms the second terminal 22.

An end portion of the second connecting portion 13 is connected to an end portion of the first connecting portion 11 by being welded thereto. In more detail, the first connecting portion 11 and the second connecting portion 13 may be coupled to each other by a tungsten inert gas (TIG) welding operation. Since the first connecting portion 11 and the second connecting portion 13 are coupled to each other by the TIG welding operation, a welded portion 15 is formed between the first connecting portion 11 and the second connecting portion 13.

The TIG welding operation is a welding method in which tungsten (W), which has a relatively high melting point, is used as a non-consumable electrode, and an inert gas such as helium (He) gas or argon (Ar) gas is supplied around the electrode so that an arc may be generated between the electrode and a base metal. Then, a rod or wire shaped filler metal is supplied to the arc so that the filler metal and the base metal may be melted by the arc and bonded to each other.

According to the TIG welding method, the arc and a weld pool may be completely shielded from surrounding atmosphere, and thus, gas such as oxygen, nitrogen, or hydrogen or impurities are not mixed in the welded metals. In addition, surface oxides may be removed while performing the welding operation by using a cleaning effect produced by the arc, which is generated between the W electrode and the base metal in the inert gas by using an alternating current (AC).

The TIG welding method for connecting the first connecting portion 11 and the second connecting portion 13 to each other may be a general TIG welding method using a wire at room temperature, a hot wire TIG welding method which uses a heating phenomenon of the welding wire, a direct current straight polarity (DCSP) TIG welding method, a pulse TIG welding method in which a current of a TIG arc is regularly changed, or a TIG arc spot welding method.

However, one or more embodiments of the present invention are not limited to the TIG welding method for fabricating the bus bars 10, and various welding methods having processing conditions suitable for connecting the first connecting portion 11 and the second connecting portion 13 formed of different metal materials from each other may be used to fabricate the bus bars 10. For example, a metal inert gas (MIG) arc welding method, a resistance welding method, a radio frequency welding method, an electron beam welding method, a plasma welding method, an ultrasonic wave welding method, or a laser welding method may be used to fabricate the bus bars 10.

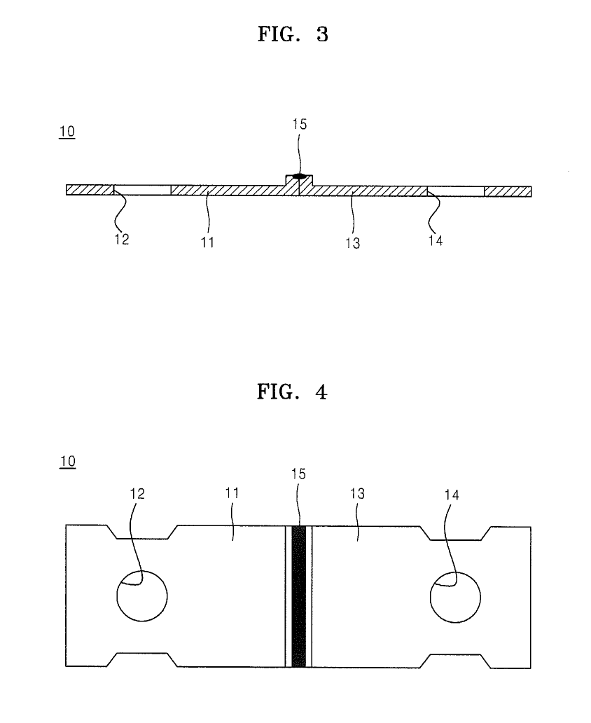

FIG. 3 is a cross-sectional view showing a side of one of the bus bars 10 in the battery module of FIG. 1, and FIG. 4 is a plan view of the bus bar 10 of FIG. 3.

The first connecting portion 11 includes a first opening 12 having a size generally corresponding to a cross-sectional area of the first terminal 21, and the second connecting portion 13 includes a second opening 14 having a size generally corresponding to a cross-sectional area of the second terminal 22.

A coupling structure between the bus bar 10 and the secondary batteries 20 will be described with reference to FIGS. 1 and 2. The first terminal 21 and the second terminal 22 protrude from the case 23 of the secondary batteries 20, and are separated from the case 23 by an insulating member 24. The insulating member 24 electrically insulates the first and second terminals 21 and 22 from the case 23.

The first terminal 21 includes a first screw surface 21a on an outer surface thereof which protrudes out of the case 23, and the second terminal 22 also includes a screw surface 22a on an outer surface thereof. Nuts 32 and 33 may be coupled to the screw surfaces 21a and 22a of the first and second terminals 21 and 22.

Before coupling the bus bar 10 to the first terminal 21, a washer 31 and the nut 32 (lower nut) are coupled to the first terminal 21. The lower nut 32 supports the bus bar 10 and at the same time, ensures an electric connecting surface.

After coupling the washer 31 and the lower nut 32 to the first terminal 21, the first connecting terminal 11 of the bus bar 10 is coupled to an upper portion of the lower nut 32. The nut 33 (upper nut) may be coupled to the screw surface 21a of the first opening 12 in a state where an upper end portion of the first terminal 21 protrudes through the first opening 12 of the first connecting portion 11. Then, a predetermined torque is applied to the upper nut 33 so that the upper nut 33 is coupled to the screw surface 21a, and thus, the first connecting portion 11, the first terminal 21, and the lower nut 32 may be maintained stably coupled.

When the second connecting portion 13 of the bus bar 10 is coupled to the second terminal 22, another washer 31 and another lower nut 32 are coupled to the second terminal 22, and after that, the second terminal 22 penetrates through the second opening 14 of the second connecting portion 13 and another upper nut 33 is coupled to the screw surface 22a of the second terminal 22.

As described above, the secondary batteries 20 and the bus bars 10 are coupled to each other by using the upper nuts 33, the lower nuts 32, and the washers 31, and accordingly with respect to two adjacent secondary batteries 20 and one bus bar 10, the first connecting portion 11 of the bus bar 10 is coupled to the first terminal 21 of one secondary battery 20, and the second connecting portion 13 of the bus bar 10 is coupled to the second terminal 22 of the other secondary battery 20. In addition, the above coupling process is repeatedly performed. Thus, the secondary batteries 20 which are successively arranged are connected by the bus bars 10 in series to assemble a battery module, and accordingly, the battery module has a large capacity.

In the battery module having the above described configuration, the secondary batteries 20 are connected to each other by the bus bars 10, each of which includes the first connecting portion 11 and the second connecting portion 13 formed of metal materials different from each other and corresponding and coupled to the first and second terminals 21 and 22 by the welding operation, and thus corrosion between the bus bars 10 and the terminals 21 and 22 of the secondary batteries 20 may be reduced. In addition, since the first connecting portion 11 of the bus bars 10 and the first terminal 21 are formed of the same material and the second connecting portion 13 of the bus bar 10 and the second terminal 22 are formed of the same material, an increase in an electrical contact resistance caused by the connection via the bus bars 10 may be reduced.

In the battery module illustrated in FIGS. 1 and 2, the bus bars 10 and the terminals 21 and 22 of the secondary batteries 20 are coupled to each other in a bolt-nut coupling structure using the nuts 32 and 33. However, one or more embodiments of the present invention are not limited thereto. That is, various coupling structures between the bus bars 10 and the secondary batteries 20 may be applied to the embodiments.

For example, the bus bars 10 and the terminals 21 and 22 of the secondary batteries 20 may be directly connected to each other through a welding operation. As described above, since the first connecting portion 11 of the bus bar 10 is formed of the same material that forms the first terminal 21 and the second connecting portion 13 of the bus bar 10 is formed of the same material that forms the second terminal 22, the bus bars 10 and the terminals 21 and 22 may be easily welded to be connected to each other. In addition, after the welding operation, the bus bars 10 and the terminals 21 and 22 formed of similar materials are bonded to each other, and thus the electric contact resistance may be reduced.

According to the one or more embodiments of the present invention, the connecting portions of the bus bars formed of different materials from each other are bonded to each other by the welding operation, and thus the bus bars may be suitable for connecting the secondary batteries having the terminals formed of different metal materials.

Since the first connecting portion of the bus bars is formed of the same material that forms the first terminal of the secondary batteries and the second connecting portion is formed of the same material that forms the second terminal of the secondary batteries, corrosion between the bus bars and the terminals may be reduced in the battery module having the structure in which the plurality of secondary batteries are connected using the bus bars, and the electrical contact resistance may be reduced.

In addition, since the bus bars include the same materials that form the terminals of the secondary batteries, the bus bars and the terminals may be coupled to each other by the welding operation easily, and the electrical contact resistance between the bus bars and the terminals may be reduced.

Although the first connecting portion and the second connecting portion of the bus bar are formed of the different metal materials from each other, the first and second connecting portions are bonded to each other in advance via a welding operation such as the TIG welding method. Therefore, the bus bars having a firm structure may be suitable for assembling the battery module.

It should be understood that the exemplary embodiments described therein should be considered in a descriptive sense only and not for purposes of limitation. Descriptions of features or aspects within each embodiment should typically be considered as available for other similar features or aspects in other embodiments.

What is claimed is:

1. A bus bar for a battery module, the bus bar comprising:
a first connecting portion comprising a first conductive metal, the first connecting portion having a first opening configured to be connected to a first terminal of a secondary battery, and an end portion; and
a second connecting portion comprising a second conductive metal different from the first conductive metal, the second connecting portion having a second opening configured to be connected to a second terminal of the secondary battery, and an end portion connected to the end portion of the first connecting portion by a weld.

2. The bus bar of claim 1, wherein the weld is a tungsten inert gas weld.

3. The bus bar of claim 1, wherein the first conductive metal comprises aluminum and the second conductive metal comprises copper or nickel.

4. A battery module comprising:
a plurality of secondary batteries, each of the secondary batteries having a first terminal and a second terminal comprising different metals; and
a plurality of bus bars, each of the bus bars including a first connecting portion comprising a first metal and connected to the first terminal of one of the secondary batteries, and a first end portion, and a second connecting portion comprising a second metal different from the first metal and connected to the second terminal of another one of the secondary batteries adjacent to the one secondary battery, and a second end portion, wherein the first end portion is connected to the second end portion by a weld.

5. The battery module of claim 4, wherein the first connecting portion and the second connecting portion are connected to each other by a tungsten inert gas weld.

6. The battery module of claim 4, wherein the first metal is substantially the same as the metal comprising the first terminal, and wherein the second metal is substantially the same as the metal comprising the second terminal.

7. The battery module of claim 6, wherein the first connecting portion comprises aluminum and the second connecting portion comprises copper or nickel.

8. The battery module of claim 4, wherein the first connecting portion has a first opening generally corresponding to the first terminal, wherein the second connecting portion has a second opening generally corresponding to the second terminal, wherein the first terminal and the second terminal each have a threaded outer surface and protrude from the first opening and the second opening, respectively, and wherein nuts are coupled to the threaded outer surface of the first and second terminals to connect the first terminal and the second terminal to the first connecting portion and the second connecting portion, respectively.

9. The battery module of claim 4, wherein the first connecting portion and the first terminal are connected to each other by a weld, and wherein the second connecting portion and the second terminal are connected to each other by a weld.
